(19) United States
(12) Patent Application Publication
(10) Pub. No.: US 2026/0294710 A1
(43) Pub. Date: Oct. 1, 2026

(54) FOAM MATTRESS COMPRISING AN UPPER BODY SLIDINGLY ARRANGED OVER A LOWER BODY AND FURTHER ARRANGED WITH INSERTS

(71) Applicant: CARE OF SWEDEN AB, Tranemo (SE)

(72) Inventors: Lars BÄCKESJÖ, Tranemo (SE); Fares AL-KHALILIY, Jönköping (SE); Erik AUGUSTSSON, Borås (SE); Karin MOLDIN, Sandared (SE)

(21) Appl. No.: 19/481,759

(22) PCT Filed: May 11, 2024
(86) PCT No.: PCT/EP2024/063010

§ 371 Date: Nov. 5, 2025

(30) Foreign Application Priority Data
May 12, 2023 (SE) 2330217-7

(51) Int. Cl. A61G 7/057

(52) U.S. Cl. CPC A61G 7/05715; A61G 2203/74

(57) ABSTRACT

A foam mattress is formed of an upper mattress body (10) and a lower mattress body (3), wherein during use the upper mattress body rests on lower mattress body (3), and the upper mattress body is arranged to be able to slide over lower mattress body and wherein one or both of the upper mattress body and lower mattress body comprise one or more inserts (7, 9, 11; 107, 109, 111,113) arranged to provide extra support for a patient 2a)

### TECHNICAL FIELD

The present invention relates to a foam mattress for reducing the risk for the occurrence of bedsores in a patient using such a mattress.

### STATE OF THE ART AND PROBLEM

In healthcare settings it is common to use beds in which the mattress supporting frame is split transversely into several sections in order to be able to raise the head end and/or feet end of the bed such that the patient will be able to be supported in different positions such as laying flat, reclining with the head raised, sitting, laying with the feet raised, etc. These different positions lead to different weights acting on the parts of the body in contact with the mattress. Prolonged contact of the body with the mattress in any given position may be uncomfortable and ultimately leads to a risk of bedsores. Bedsores—also called pressure ulcers and decubitus ulcers—are injuries to skin and underlying tissue resulting from prolonged pressure on the skin. This prolonged pressure is caused by the patient's own body weight and causes a reduction in the blood circulation to the skin and underlying tissues. An exacerbating factor is shear which occurs when layers of skin and/or tissue move relative to each other. This shear may cause blood vessels to be stretched or even broken and the effect is to reduce or even cut off blood circulation to the affected areas. Shear occurs in reclining or sitting patients when the weight of the body causes tissues to move downwards in relation to the skin which, in the region of the tailbone, is unable to move due to friction against the sheet. Shear may also arise in sitting patients in the neck or shoulder region and above and below the knee. Bedsores most often develop on skin that covers bony areas of the body, such as the heels, ankles, hips and tailbone. People most at risk of bedsores have medical conditions that limit their ability to change positions or cause them to spend most of their time in a bed or chair. A solution to this problem known from WO2007129981 has been to make provide a mattress with regions which have different degree of hardness, with the hardest regions being positioned in parts of the mattress where increased support is needed for areas of the patient such as the curve of the back and the thighs.

An object of the present invention is to be able to provide a flexible mattress that can help to reduce the risk of bedsores in a patient.

### BRIEF ACCOUNT OF THE INVENTION

A flexible mattress which is more comfortable for a patient and may help to reduce the risk of bedsores can be achieved by a mattress as claimed in claim 1.

Thanks to the invention the advantage is achieved that the comfort of a patient using the mattress is increased and the risk of bedsores due to shear stress may be reduced.

The mattress is comparatively simple in design, which gives a cost benefit.

### BRIEF DESCRIPTION OF THE DRAWINGS

In the following, the invention will be described in greater detail with reference to the attached drawing figures which are not to scale and in which:

FIG. 1a) shows schematically a plan view of a flat mattress according to a first embodiment of the invention,

FIG. 1b) shows schematically a lateral view of a flat mattress according to a first embodiment of the invention,

FIG. 1c) shows schematically a view from one end of a flat mattress according to a first embodiment of the invention,

FIG. 2a) shows schematically a lateral view through section A-A of the mattress of FIG. 1a),

FIG. 2b) shows schematically a transverse view through line B-B of FIG. 1a),

FIG. 2c) shows schematically a transverse view through line C-C of FIG. 1a),

FIG. 3 shows schematically a lateral view of a mattress according to the first embodiment of the invention when in use with a sitting patient,

FIG. 4 shows schematically a perspective view of a mattress according to the first embodiment of the invention,

FIG. 5. shows schematically a perspective view according to FIG. 3 in which components have been extracted from the mattress,

FIG. 6 shows schematically a lateral view of a mattress according to the second embodiment of the invention when flat,

FIG. 7 shows schematically a lateral e view of a mattress according to the second embodiment of the invention when in use with a sitting patient.

### DETAILED DESCRIPTION OF THE INVENTION

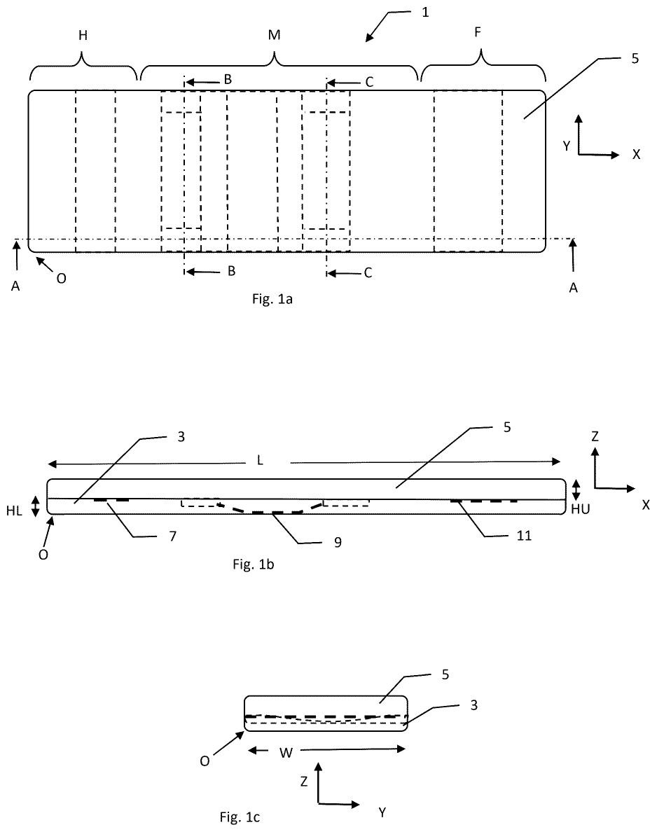

FIG. 1 shows a plan view of a foam mattress 1 according to a first embodiment of the invention as seen from above. In the figures the X-, Y- and Z-directions relate to the longitudinal, transverse and height directions with respect to a mattress with the origin O at the bottom, right hand, head end of the mattress when seen from the view of a patient lying faceup on the mattress. For the sake of simplicity, the mattress will be described as if divided in three longitudinal sections; a head section H, a middle section M and a foot section F. The head section comprises the portion of the mattress upon which a person rests at least his/her head and preferably also his/her shoulders. The foot section comprises the lower portion of the mattress upon which the feet and also the legs are positioned. The middle section forms the largest portion of the mattress and comprises the position of the torso and the thighs and extends between the head section and the foot section. These sections should by no means be seen as delimiting for the mattress as such, but are just a way to facilitate the disclosure of the mattress. The mattress may be symmetrical about the central longitudinal axis and it may be symmetrical about the central transverse. The figure shows cross-sectional lines A-A, B-B and C-C from which will be described in the following figures.

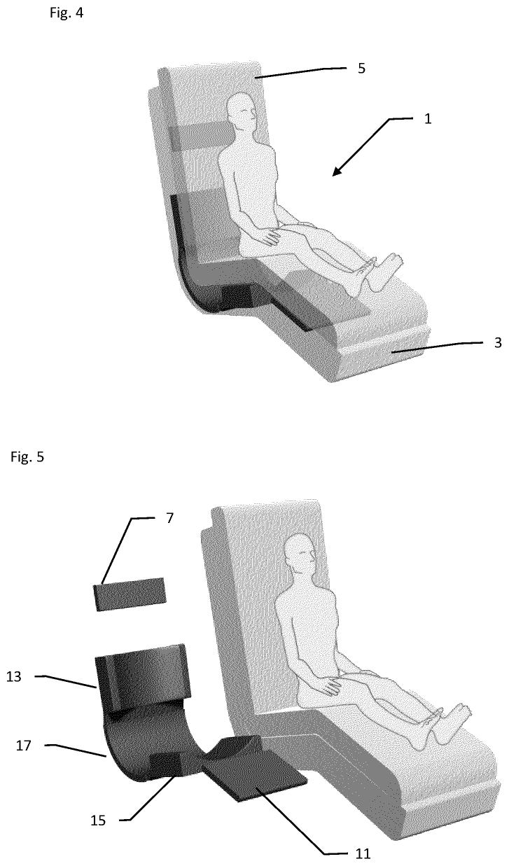

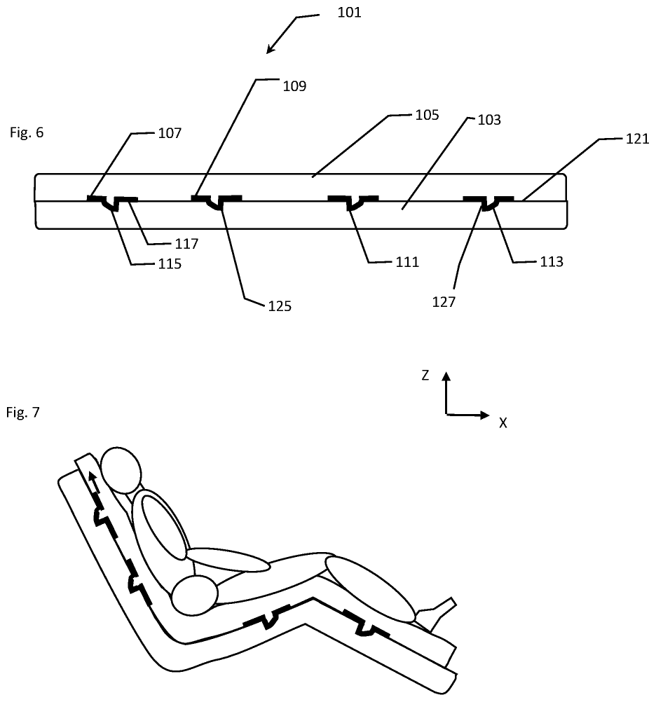

A first embodiment of a mattress according to the invention is shown in FIGS. 1-5. The mattress 1 is illustrated as being substantially cuboid but it is possible for the invention to be applied to mattresses of any shape, such as round, triangular, wedge-shaped, etc. Mattress 1 has a length L, width W and height H. It comprises a substantially cuboid lower mattress body 3 of length L, width W and height HL intended to rest on a bed frame or the like (not shown) and a substantially cuboid upper mattress body 5 of length L, width W and height HU which is intended to rest on lower mattress body 3. Heights HL and HU are substantially equal to height H. Upper mattress body 5 is arranged to be able to slide over lower mattress body 3. This can be achieved by ensuring that the coefficient of friction between the contacting surfaces of the upper and lower mattresses is low enough to permit relative movement between the mattress when the mattresses, when occupied by a user, is moved from a laying position to a sitting position. Upper mattress body is preferably formed from a slab of foam material which may be substantially homogeneous and has a maximum hardness h1.

Lower mattress body 3 is preferably formed from a slab of foam material with a second hardness h2. Preferably hardness h1 of upper mattress body 3 is equal to or, more preferably, lower than the second hardness h2 of the lower mattress body so that the softest foam is closest to the patient. Lower mattress body comprises a plurality of support-providing insets made of a material with a third hardness h3 which is greater than the second hardness h2 which allows the inserts to provide increased support in the areas above them.

Preferably the lower mattress body comprises three support-providing insets—a neck and shoulder insert 7 positioned in an area corresponding to the neck and shoulder area of a sitting patient, a lower back to upper thigh insert 9 positioned in an area corresponding to the lower back and upper thighs of a sitting patient and a calf insert 11 positioned in an area corresponding to the calves of a sitting patient.

The neck and shoulder insert 7 is intended to provide a region of increased support of the neck and shoulders of a sitting patient and does not need to provide any positioning function so it can consist of a cuboid slab of material which extends across substantially the whole width of the mattress (i.e. it is of width W) and has a uniform thickness t1. It extends a distance LN in the longitudinal direction which is sufficient to provide support for the neck and/or shoulders of a patient. Preferably LN is equal to or greater than 10 cm and less than or equal to 25 cm.

The calf insert 9 is intended to provide a region of increased support for the calves and lower legs of a sitting patient and does not need to provide any positioning function so it can consist of a cuboid slab of material which extends across substantially the whole width of the mattress and has a uniform thickness t2. It extends a distance LC in the longitudinal direction which is sufficient to provide support for the calves and lower leg of a patient. Preferably LC is equal to or greater than 10 cm and less than or equal to 25 cm.

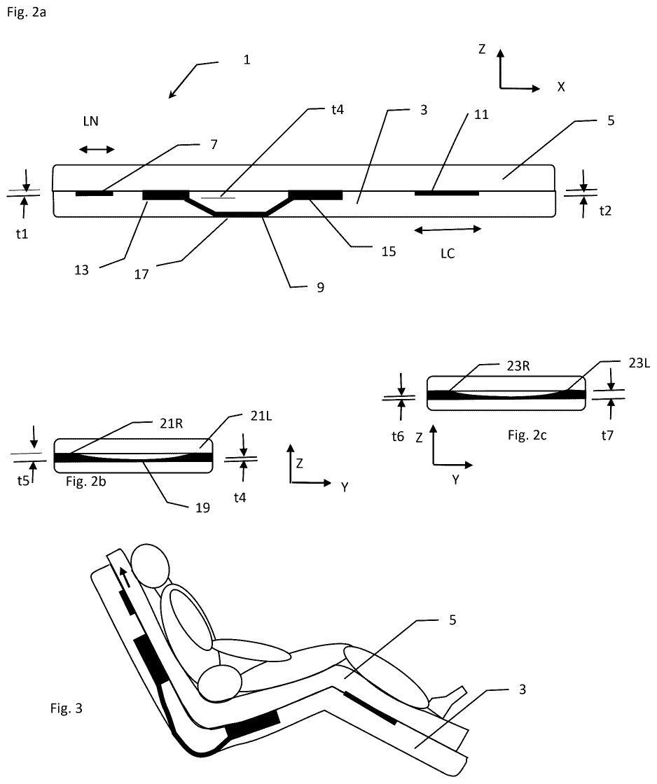

The lower back to upper thigh insert 11 is intended to provide support for the region extending from the lower back to the thighs of a patient. Preferably it also provides a positioning function which helps to centralise the patient in the centre of the mattress. The lower back to upper thigh insert 11 comprises a lower back support 13 and a thigh support 15 which are connected by a pelvic support 17. Preferably the lower back and thigh supports 13, 15 each have a concave transverse profile adapted to centralise the patient in the centre of the mattress. Examples of transverse profiles are shown in the cross-sections in FIGS. 2b) and 2c). Each of these transverse profiles have shallow central portions 19 which curve up towards the thicker right-hand and left-hand edges 21R, 21L respectively 23R, 23L of the lower back support respectively thigh support. As the thicker edges of the supports are made of a harder material than the portion of the mattress lying over them and between them, they will resist any movement of the patient in the transverse direction and thus will help the patient remain in the centre of the bed. In order to prevent the lower back and thigh supports from moving apart due to the weight of the patient, they are joined by the pelvic support which ties them together. In order to reduce the pressure on the pelvic region of the patient, the pelvic support is preferably positioned in the lower half in the Z-direction of the lower mattress body so that the deformation of the upper mattress body necessary to conform to the shape of the patient's pelvic region is not unduly restricted. Preferably the pelvic support is a slab of foam of substantially constant thickness t3 which preferably is less than or equal to 50% of the height HL of the lower mattress body and more preferably less than or equal to 25% of the height HL.

Preferably the lower back support has a central portion which is concave when viewed from an end of the mattress. Therefore, it has a thickness t4 in the centre which is the same as or less than the thickness t3 of the pelvic support 17 and has a thickness 15 at the outer edges 21R, 21L, which is greater than t3. Preferably thickness t5 is equal to or less than one half of the height of the lower mattress body HL and equal to or greater than 25% of the thickness HL. The lower back support is in the upper half of the lower mattress body in the Z-direction so that it is positioned closer to the upper mattress body than the pelvic support is. Concave portions help to centralise a patient on the mattress.

Preferably the thigh support has a central portion which is concave when viewed from an end of the mattress. Thus, it has a thickness t6 in the centre which is the same as or less than the thickness t3 of the pelvic support 17 and has a thickness t7 at the outer edges 23R, 23L, which is greater than t3. Preferably thickness t7 is equal to or less than one half of the height of the lower mattress body HL and equal to or greater than 25 of the thickness HL. The thigh support is in the upper half of the lower mattress body in the Z-direction so that it is positioned closer to the upper mattress body than the pelvic support is.

When the mattress is in a flat position the weight of a patient is distributed relatively evenly over the mattress but when the mattress is in a sitting position, areas with pressure concentrations can arrive. When the mattress is moved from a flat position to a sitting position, the relative movement of the upper mattress body with respect to the lower mattress body brings the inserts in positions where they can provide support for a sitting patient in areas which otherwise would not be supported and thereby even out the pressure on the patient.

FIGS. 3-5 show that when the mattress is moved into a sitting position the upper mattress is bent in a tighter curve than the lower mattress body in the pelvic region of the patient, and this bending, combined with the weight of the patient, results in a shear force between the upper and lower mattress bodies which causes the upper mattress body to be displaced in the direction towards the head end of the mattress. The bending of the upper and lower mattress bodies causes deformation of the pelvic support which curves to give support to the pelvic region of the patient and at the same time the relative movement of the upper and lower mattress bodies brings the neck and shoulders, respectively the calves of the patient over the neck and shoulder insert and calf insert so that support is provided in these regions.

A second embodiment of a mattress according to the invention is shown in FIGS. 16 and 7. The mattress 101 may be substantially cuboid and have a length L, width W and height H. It may comprise a substantially cuboid lower mattress body 103 of length L, width W and height HL intended to rest on a bed frame or the like (not shown) and a substantially cuboid upper mattress body 105 of length L, width W and height HU which is intended to rest on lower mattress body 103. Upper mattress body is arranged to be able to slide over lower mattress body. Upper mattress body is preferably formed from a slab of foam material which may be substantially homogeneous and have a maximum hardness h1.

Lower mattress body 103 is preferably formed from a slab of foam material with a second hardness h2. Preferably hardness h1 of upper mattress body 103 is equal to or more preferably lower than the second hardness h2 of the lower mattress body 105 so that the softest foam is closest to the patient for reasons of comfort.

Upper mattress body 105 comprises a plurality of support-providing insets made of a material with a third hardness h3 which is greater than the second hardness h2 which allows the support-providing inserts to provide increased support in the areas above them. In this example of the second embodiment of the invention there are four inserts, namely neck and shoulder insert 107, small of the back insert 109, thigh insert 111 and calf insert 113, but the number of inserts could be more or less than four.

Each insert is wedge-shaped and comprises a wedge-shaped profile 115 which extends from a substantially planar wedge support body 117 positioned on the lower surface 119 of the upper mattress body so that each wedge-shaped profile is in contact with the lower mattress body. As the material of the lower mattress body has a hardness which is lower than that of the wedge-shaped profiles, and as the wedge-shaped profiles are supported on planar bodies which resist penetration of the upper mattress body by the inserts, the wedge-shaped profiles deform the underlying upper surface 121 of the lower mattress body and extend into the lower mattress body. Each wedge-shaped profile comprises a first transversely extending face 125 which is substantially perpendicular to the lower surface of the upper mattress body and which faces towards the foot end of the mattress, and a second transversely extending face 127 which is inclined towards the upper surface of the lower mattress body and which faces towards the head end of the mattress.

For ease of manufacturing each insert can be identical and the desired support of the body parts of the patient can be achieved by adapting the distance between inserts—positioning the inserts closer together provides increases support and vice versa. Alternatively, increased support can be achieved by extending the inserts longer and/or thicker or making them of harder material and reduced support can be achieved by making inserts shorter and/or thinner and/or of softer material.

When the mattress is raised into a sitting position the radius of curvature of the upper mattress body in the pelvic region of the patient is greater than the radius of curvature of the lower mattress body and this induces shear forces which tend to move the upper mattress body in the direction towards the head of the bed. The inclined faces of the wedge-shaped profiles of the neck and shoulder insert 107 and small of the back insert 109 face in this direction and do not prevent this relative movement. Thigh insert 111 and calf insert 113 can face in the opposite direction to resist this movement which helps to prevent an unloaded mattress from moving when a patient is being loaded onto the mattress. As the weight on the thigh and calf inserts is less than that of the weight on the neck and shoulder and small of the back inserts, the movement of the upper mattress body is not prevented. Alternatively, one of more of the thigh and calf inserts may face in the same direction as the neck and shoulder and small of the back inserts. Once the relative movement between the upper mattress body and lower mattress body has finished, the perpendicular faces of the wedge-shaped profiles resist movement of the upper mattress body back towards the foot of the bed until the mattress is moved back into the flat position.

A third embodiment of the present invention comprises at least a lower back to upper thigh insert of the type described in connection with the first embodiment of the invention and at least one wedge-shaped profile, preferably in the neck region or calf region, in accordance with the second embodiment of the invention.

A further embodiment of the present invention comprises a lower mattress body with at least two inserts and an upper mattress body with at least two wedge-shaped inserts wherein at least one wedge-shaped insert in the upper mattress body is arranged opposite an insert in the lower mattress body, for example a wedge-shaped neck and shoulder insert is arranged opposite a neck and shoulder insert in a lower mattress body.

The mattress according to the invention has been described from the viewpoint of use within medical care. It should be understood that the mattress according to the invention is suitable not only for such users but that it also can be used by persons that for other reasons spend a lot of time in bed. Private use of the mattress is also within the scope of the invention, in newer beds that increasingly comprise a sitting function.

1. A foam mattress (1; 101) comprising a lower mattress body (3; 103) and an upper mattress body (5; 105) wherein during use the upper mattress body rests on the lower mattress body (3; 103), characterised in that the upper mattress body is arranged to be able to slide over the lower mattress body;
wherein the upper mattress body (5; 105) is formed from a slab of foam material with a first hardness h1, the lower mattress body (3; 103) is formed from a slab of foam material with a second hardness h2 wherein the first hardness h1 of upper mattress body (5; 105) is equal to or lower than the second hardness h2 of the lower mattress body (3; 103) and
the lower mattress body (3) and/or the upper mattress body (105) comprise at least one support-providing insert (7, 9, 11; 107, 109, 111,113) made of a material with a third hardness h3 which is greater than the second hardness h2.

2. The foam mattress according to claim 1 wherein the lower mattress body (3) comprises a lower back to upper thigh insert (9) for providing support in a lower back to upper thigh region of the mattress.

3. The foam mattress according to claim 1 wherein the upper mattress body (105) comprises a wedge-profiled neck and shoulder insert (107) for providing support in a neck and shoulder region of the mattress and a wedge-profiled calf insert (113) for providing support in a calf region of the mattress.

4. The foam mattress according to claim 1 wherein the lower mattress body comprises a neck and shoulder insert (7) for providing support in a neck and shoulder region of the mattress and/or a calf insert (11) for providing support in a calf region of the mattress.

5. The foam mattress according to claim 1 wherein the upper mattress body comprises a wedge-profiled lower back support body (109) and/or a wedge-profiled thigh support body (111).

6. The foam mattress according to claim 2 characterised in that the lower back to upper thigh insert comprises a lower back support (13) and a thigh support (15) which are connected by a pelvic support (17).

7. The foam mattress according to claim 6 characterised in that at least one of the lower back support and the thigh support has a central portion which is concave when viewed from an end of the mattress.
